(19) United States
(12) Patent Application Publication
(10) Pub. No.: US 2019/0001636 A1
(43) Pub. Date: Jan. 3, 2019

(54) MULTILAYER FILMS, ARTICLES COMPRISING THE SAME, AND METHODS OF MAKING MULTILAYER FILMS

(71) Applicant: Dow Global Technologies LLC, Midland, MI (US)

(72) Inventors: Eva-Maria Kupsch, Horgen (CH); Yushan Hu, Pearland, TX (US)

(73) Assignee: Dow Global Technologies LLC, Midland, MI (US)

(21) Appl. No.: 15/752,394

(22) PCT Filed: Sep. 9, 2016
(86) PCT No.: PCT/US2016/052434

§ 371 Date: Feb. 13, 2018

Related U.S. Application Data
(60) Provisional application No. 62/232,064, filed on Sep. 24, 2015.

(51) Int. Cl. B32B 27/08; B32B 27/36; B32B 27/34; B32B 27/30; B32B 27/32; B65D 65/40

(52) U.S. Cl. CPC B32B 27/08; B32B 27/36; B32B 27/34; B32B 27/306; B32B 27/32; B32B 2270/00; B65D 65/40; B32B 2250/24; B32B 2439/70; B32B 2439/80; B32B 27/308

(57) ABSTRACT

Embodiments of the present invention relate to multilayer films, packages formed therefrom, and methods of preparing multilayer films. In one aspect, a multilayer film comprises a coextruded, multilayer film comprising at least five layers in which Layer A is a skin layer, Layer B is a tie layer, Layer C is a barrier layer, Layer D is a second tie layer, and Layer E is polyolefin, each layer having opposing facial surfaces and arranged in the order A/B/C/D/E. Layer A comprises polyethylene terephthalate, Layer C comprises polyamide or ethylene vinyl alcohol, and Layer E comprises polypropylene or polyethylene.

### FIELD

The disclosure relates to multilayer films, to articles comprising such multilayer films, and to methods of making such multilayer films.

### INTRODUCTION

Liquid foods, such as juice, tea, milk, clear soup, and other liquid food types are packaged aseptically on aseptic packaging lines to achieve longer shelf-life times at ambient temperature. Aseptic processing is the process by which an aseptic product is packaged in a sterile packaging material in a way that maintains sterility. Sterility of the packaged good is achieved with a flash-heating of the packaged food (temperature between 195 and 295° F. (91 to 146° C.)). The packaging material is sterilized either by passing through a hydrogen peroxide bath, by spraying hydrogen peroxide or by electron beam processing or electron irradiation, of the packaging material. The sterile food is packaged into the sterilized packaging material in a sterile chamber of the aseptic packaging line. Another application where aseptic processing is utilized is medical packaging where the pharmaceutical or medical products are aseptically packaged in sterilizable pouches. Such packages typically have similar property requirements as packages that are aseptically processed for food applications. The packaging material used for such processes generally needs to have a combination of stiffness, temperature resistance, chemical resistance, barrier properties, sealability, and other properties.

Typical packaging material for such applications includes a layer that provides stiffness which could be a paper or paper board layer, a barrier layer which could be an aluminum foil layer or a barrier resin layer such as polyamide or ethylene vinyl alcohol copolymer layers, and a sealant layer which could be polyethylene or polypropylene. For example, one typical package design uses the following packaging structure: polyethylene/paper board/PE and-or polyethylene carboxylic acid copolymer/aluminum foil/polyethylene carboxylic acid copolymer/polyethylene. Such packaging material is produced with extrusion coating and lamination technology, in which the paper board is coated in the first step with polyethylene, then laminated in a second step to aluminum foil, and then in a third step, the polyethylene/paper board/PE and/or polyethylene carboxylic acid copolymer/aluminum foil intermediate laminate is coated with coextruded polyethylene carboxylic acid copolymer for adhesion to aluminum and polyethylene as a sealant layer. In such a process, the individual steps can be performed in different orders. Another typical package design uses a triplex laminate structure such as the following: oriented polyethylene terephthalate (OPET)/adhesive/aluminum foil/adhesive/polyolefin. Such packaging material is produced with adhesive lamination technology in which the OPET film is laminated with a reactive adhesive system to aluminum foil. This duplex laminate has to cure to allow the complete reaction of the adhesive system which typically takes 3 to 14 days. The pre-manufactured duplex laminate has to be laminated with a reactive adhesive system to the polyolefin film to form the final triplex structure. This triplex laminate has to cure to allow the complete reaction of the adhesive system which typically takes 3 to 14 days.

There remains the need for a new multilayer packaging material that simplifies the process to produce packaging material for aseptic packaging applications.

### SUMMARY

The present invention provides multilayer films which advantageously provide one or more desirable properties. Further, the multilayer films comprise layers that permit coextrusion of the multilayer film in a single extrusion step. For example, multilayer films of the present invention can form packages that can be aseptically processed without requiring multiple extrusion steps, lamination, cure, etc. In addition, multilayer films, in some embodiments of the present invention, do not comprise an aluminum foil layer such that packages formed from such films have a lower carbon footprint than typical package designs.

In one aspect, the present invention provides a coextruded, multilayer film comprising at least five layers in which Layer A is a skin layer, Layer B is a tie layer, Layer C is a barrier layer, Layer D is a second tie layer, and Layer E is polyolefin, each layer having opposing facial surfaces and arranged in the order A/B/C/D/E. In one such aspect:

Layer A comprises polyethylene terephthalate (PET);

Layer B comprises a maleic anhydride grafted polymer comprising ethylene monomer, a top facial surface of Layer B being in adhering contact with a bottom facial surface of Layer A;

Layer C comprises polyamide or ethylene vinyl alcohol;

Layer D comprises either:
(1) a maleic anhydride grafted polymer comprising ethylene monomer;
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene, a top facial surface of Layer D being in adhering contact with a bottom facial surface of Layer C; and

Layer E comprises polypropylene or polyethylene and, a top facial surface of Layer E being in adhering contact with a bottom facial surface of Layer D.

As discussed below, the present invention also provides packages (e.g., aseptic packages) formed from multilayer films of the present invention, as well as methods of preparing multilayer films of the present invention.

These and other embodiments are described in more detail in the Detailed Description.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials which comprise the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or polymer mixture.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene-based polymer,” as used herein, refers to a polymer that comprises, in polymerized form, a majority amount of ethylene monomer (based on the weight of the polymer), and optionally may comprise one or more comonomers.

The term, “ethylene/α-olefin interpolymer,” as used herein, refers to an interpolymer that comprises, in polymerized form, a majority amount of ethylene monomer (based on the weight of the interpolymer), and an α-olefin.

The term, “ethylene/α-olefin copolymer,” as used herein, refers to a copolymer that comprises, in polymerized form, a majority amount of ethylene monomer (based on the weight of the copolymer), and an α-olefin, as the only two monomer types.

The term, “propylene-based polymer,” as used herein, refers to a polymer that comprises, in polymerized form, a majority amount of propylene monomer (based on the weight of the polymer), and optionally may comprise one or more comonomers.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend.

The term “in adhering contact” and like terms mean that one facial surface of one layer and one facial surface of another layer are in touching and binding contact to one another such that one layer cannot be removed for the other layer without damage to the in-contact facial surfaces of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

In one embodiment, a coextruded, multilayer film of the present invention comprises at least five layers in which Layer A is a skin layer, Layer B is a tie layer, Layer C is a barrier layer, Layer D is a second tie layer, and Layer E is polyolefin, each layer having opposing facial surfaces and arranged in the order A/B/C/D/E. In some embodiments of the multilayer film:

Layer A comprises polyethylene terephthalate (PET);

Layer B comprises a maleic anhydride grafted polymer comprising ethylene monomer, a top facial surface of Layer B being in adhering contact with a bottom facial surface of Layer A;

Layer C comprises polyamide or ethylene vinyl alcohol;

Layer D comprises either:
(1) a maleic anhydride grafted polymer comprising ethylene monomer;
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene, a top facial surface of Layer D being in adhering contact with a bottom facial surface of Layer C; and

Layer E comprises polypropylene or polyethylene and, a top facial surface of Layer E being in adhering contact with a bottom facial surface of Layer D. Layer E, in some embodiments, comprises polypropylene and in other embodiments, comprises polyethylene.

In embodiments where Layer B or Layer D (or Layer G, wherein Layer G is a third tie layer as discussed below) comprises a maleic anhydride grafted polymer comprising ethylene monomer, the maleic anhydride grafted polymer comprising ethylene monomer can comprise maleic anhydride grafted polyethylene, maleic anhydride grafted ethylene acrylate, maleic anhydride grafted ethylene vinyl acetate. In some embodiments, Layer B (and/or Layer D and/or Layer G) can further comprise, in addition to a maleic anhydride grafted polymer comprising ethylene monomer, a second polymer. In some such embodiments, the second polymer can comprise a copolymer of ethylene and at least one polar monomer. For example, in some such embodiments, the second polymer can comprise an ethylene alkyl acrylate copolymer (e.g., ethylene methyl acrylate, ethylene ethyl acrylate, ethylene butyl acrylate, or combinations thereof), an ethylene vinyl acetate copolymer, or combinations thereof. In some embodiments, Layer B (and/or Layer D and/or Layer G) comprises a blend of maleic anhydride grafted polyethylene and ethylene alkyl acrylate copolymer (e.g., ethylene methyl acrylate, ethylene ethyl acrylate, ethylene butyl acrylate, or combinations thereof). Layer B (and/or Layer D and/or Layer G), in some embodiments, comprises a blend of maleic anhydride grafted polyethylene and ethylene vinyl acetate copolymer. In some embodiments, Layer B (and/or Layer D and/or Layer G) comprises a blend of maleic anhydride grafted polyethylene and ethylene ethyl acrylate copolymer.

In some embodiments, a top facial surface of Layer C is in adhering contact with a bottom facial surface of Layer B. In other embodiments, other layers can be positioned between Layer B and Layer C. For example, in some embodiments, a coextruded multilayer film further comprises Layer F and Layer G, wherein a top facial surface of Layer F is in adhering contact with a bottom facial surface of Layer B, wherein a top facial surface of Layer G is in adhering contact with a bottom facial surface of Layer F, and wherein a top facial surface of Layer C is in adhering contact with a bottom facial surface of Layer G (e.g., the film structure is A/B/F/G/C/D/E). In some such embodiments, Layer F comprises polypropylene, and Layer G is a third tie layer that comprises either:
(1) a maleic anhydride grafted polymer comprising ethylene monomer, or
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene.

In some embodiments, Layer G comprises the same composition as Layer D. In some embodiments, Layers B, D, and G each comprise the same composition.

Coextruded, multilayer films of the present invention can include other combinations of components in the various layers as further disclosed herein.

In some embodiments, coextruded, multilayer films of the present invention have a thickness of 15 microns to 2.5 centimeters.

Coextruded, multilayer films of the present invention, in some embodiments, can advantageously be coextruded in a single step. In some embodiments, the coextruded, multilayer film is a blown film; in other embodiments, the coextruded, multilayer film is a cast film. The ability to coextrude multilayer films, while still providing desirable properties, can be advantageous for a number of reasons. For example, in the production of aseptic packages, the elimination of multiple extrusion steps, lamination, cure, etc. simplifies manufacturing. Likewise, the elimination of aluminum foil layers and/or paperboard from packages such as aseptic packages can also be advantageous.

Embodiments of the present invention also related to aseptic packages. An aseptic package, in some embodiments, is formed from a multilayer film of the present invention. The aseptic package, in some embodiments, can be a liquid packaging material (i.e., constructed so as to store a liquid). In some embodiments, an aseptic package comprises a liquid.

Embodiments of the present invention also related to methods of preparing multilayer films. The films can be blown films or cast films, in some embodiments. In one embodiment of a method of preparing a multilayer film comprising at least five layers, wherein the layers are arranged in the order A/B/C/D/E, the method comprises:

coextruding Layer A, Layer B, Layer C, Layer D, and Layer E, such that a top facial surface of Layer B is in adhering contact with a bottom facial surface of Layer A, a top facial surface of Layer C is in adhering contact with a bottom facial surface of Layer B, a top facial surface of Layer D is in adhering contact with a bottom facial surface of Layer C, and a top facial surface of Layer E is in adhering contact with a bottom facial surface of Layer D;

wherein:

Layer A comprises polyethylene terephthalate (PET);

Layer B comprises a maleic anhydride grafted polymer comprising ethylene monomer;

Layer C comprises polyamide or ethylene vinyl alcohol;

Layer D comprises either:
(1) a maleic anhydride grafted polymer comprising ethylene monomer, or
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene; and

Layer E comprises polypropylene or polyethylene, a top facial surface of Layer E being in adhering contact with a bottom facial surface of Layer D.

In one embodiment of a method of preparing a multilayer film comprising at least seven layers, wherein the layers are arranged in the order A/B/C/D/E/F/G, the method comprises:

coextruding Layer A, Layer B, Layer C, Layer D, Layer E, Layer F, and Layer G such that a top facial surface of Layer B is in adhering contact with a bottom facial surface of Layer A, a top facial surface of Layer C is in adhering contact with a bottom facial surface of Layer B, a top facial surface of Layer D is in adhering contact with a bottom facial surface of Layer C, and a top facial surface of Layer E is in adhering contact with a bottom facial surface of Layer D, a top facial surface of Layer F is in adhering contact with a bottom facial surface of Layer E, a top facial surface of Layer G is in adhering contact with a bottom facial surface of Layer F;

wherein:

Layer A comprises polyethylene terephthalate (PET);

Layer B comprises a maleic anhydride grafted polymer comprising ethylene monomer;

Layer C comprises polypropylene;

Layer D comprises either:
(1) a maleic anhydride grafted polymer comprising ethylene monomer, or
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene;

Layer E comprises polyamide or ethylene vinyl alcohol;

Layer F comprises either:
(1) a maleic anhydride grafted polymer comprising ethylene monomer, or
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene; and

Layer G comprises polypropylene or polyethylene.

### Outer Layer (Layer A)

In embodiments of the present invention, Layer A of the coextruded, multilayer film is an outer layer or skin layer of the film. Layer A can comprise any polyethylene terephthalate (PET) known to those of skill in the art to be suitable as an outer layer of a multilayer film. A PET skin layer can give the film stiffness, heat resistance, puncture resistance, and/or barrier properties in various embodiments.

### Barrier Layer (Layer C)

In embodiments of the present invention, Layer C of the coextruded, multilayer film is a barrier layer. The barrier layer, Layer C, may comprise one or more polyamides (nylons) and/or ethylene vinyl alcohol copolymers (EVOH), and can include a scavenger materials and compounds of heavy metals like cobalt with MXD6 nylon. EVOH includes a vinyl alcohol copolymer having 27 to 44 mol % ethylene, and is prepared by, for example, hydrolysis of vinyl acetate copolymers. Examples of commercially available EVOH that can be used in embodiments of the present invention include EVAL™ from Kuraray and Noltex™ from Nippon Goshei. In embodiments where the barrier layer comprises polyamide, the polyamide can include polyamide 6, polyamide 9, polyamide 10, polyamide 11, polyamide 12, polyamide 6,6, polyamide 6/66 and aromatic polyamide such as polyamide 61, polyamide 6T, MXD6, or combinations thereof.

As set forth further herein, in some embodiments, a multilayer film can comprise further barrier layers in addition to Layer C. For example, in some embodiments, three adjacent barrier layer can be provided in the multilayer film. In one such embodiment, the three adjacent barrier layers can be arranged as follows: polyamide/ethylene vinyl alcohol/polyamide.

### Tie Layer (Layer B)

The composition of Layer B in the films according to the present invention, often referred to as a “tie” layer, is selected to be adhered by coextrusion to Layer A and optionally to Layer C (or optionally another layer) in the production of multilayer films of the present invention. In some embodiments, a bottom surface of Layer B is in adhering contact with a top surface of Layer C while in other embodiments, one or more additional layers are between Layer B and Layer C.

Layer B comprises a maleic anhydride grafted polymer comprising ethylene monomer. In some embodiments, Layer B further comprises at least one additional polymer. Examples of commercially available maleic anhydride grafted polymers comprising ethylene monomer that can be used in some embodiments include AMPLIFY™ TY 1053H, AMPLIFY™ TY 1057H, AMPLIFY™ TY 1052H, and AMPLIFY™ TY 1151, each of which are available from The Dow Chemical Company; BYNEL 41E710, BYNEL 4033, BYNEL 4140, FUSABOND E Series functionalized ethylene-based modifiers and M Series random ethylene copolymers available from DuPont; and OREVAC OE825 from Arkema.

Examples of maleic anhydride grafted polymers comprising ethylene monomer that can be used in Layer B include maleic anhydride grafted polyethylene, maleic anhydride grafted ethylene acrylate, maleic anhydride grafted ethylene vinyl acetate, and combinations thereof.

Examples of polymers that can be in Layer B, in addition to maleic anhydride grafted polymer comprising ethylene monomer, include ethylene alkyl acrylate copolymers (e.g., AMPLIFY EA from The Dow Chemical Company, ELVALOY AC from DuPont, and LOTRYL from Arkema), ethylene vinyl acetate copolymers, elastomeric ethylene/α-olefin copolymers including octene or hexene or butene or propylene (e.g., ENGAGE polyolefin elastomers and AFFINITY polyolefin plastomers from The Dow Chemical Company, and Queo plastomers from Borealis), propylene based copolymers with ethylene (e.g., VERSIFY plastomers and elastomers which are commercially available from The Dow Chemical Company), ethylene-based olefin block copolymers (e.g., INFUSE olefin block copolymers commercially available from The Dow Chemical Company), and crystalline block composite (as defined below), and combinations thereof. For example, an ethylene alkyl acrylate copolymer can be ethylene methyl acrylate, ethylene ethyl acrylate, ethylene butyl acrylate, or combinations thereof. Examples of blends of maleic anhydride grafted polymers comprising ethylene monomer and of ethylene alkyl acrylate copolymers that can be used as a tie layer in some embodiments of the present invention are set forth in PCT Publication No. WO2014/035483.

In one embodiment, Layer B comprises a blend of 10-50% of a maleic anhydride grafted polyethylene, having a maleic anhydride concentration of 0.1 and 2.0%, and 50-90% ethylene alkyl acrylate copolymer (e.g., ethylene ethyl acrylate copolymer, et al.). In another embodiment, Layer B comprises a blend of 10-50% of a maleic anhydride grafted polyethylene, having a maleic anhydride concentration of 0.1-2.0%, and 50-90% ethylene vinyl acetate copolymer.

### Layer E

Layer E comprises polyethylene, polypropylene, or combinations thereof. Layer E can comprise any polyethylene or polypropylene known to those of skill in the art to be suitable for use as a layer in a multilayer film based on the teachings herein.

The polypropylene that can be used in Layer E, as well as other layers in the multilayer film in some embodiments, can be homopolymer (hPP), random copolymer polypropylene (rcPP), impact copolymer polypropylene (hPP+at least one elastomeric impact modifier) (ICPP) or high impact polypropylene (HIPP), high melt strength polypropylene (HMS-PP), isotactic polypropylene (iPP), syndiotactic polypropylene (sPP), and combinations thereof. The polypropylene that can be used in Layer E, as well as other layers in the multilayer film in some embodiments, can also be a propylene-alpha-olefin interpolymer, as described in more detail with regard to Layer D. The polypropylene that can be used in Layer E, as well as other layers in the multilayer film in some embodiments, can also be an EPDM material, as described in more detail with regard to Layer D.

The polyethylene that can be used in Layer E, as well as other layers in the multilayer film, in some embodiments, can be ultralow density polyethylene (ULDPE), low density polyethylene (LDPE), linear low density polyethylene (LLDPE), medium density polyethylene (MDPE), high density polyethylene (HDPE), high melt strength high density polyethylene (HMS-HDPE), ultrahigh density polyethylene (UHDPE), homogeneously branched ethylene/α-olefin copolymers made with a single site catalyst such as a metallocene catalyst or a constrained geometry catalyst, and combinations thereof. In a further embodiment, the polyethylene has a density greater than 0.950 g/cc (i.e., a HDPE).

### Tie Layer (Layer D)

The composition of Layer D in the films according to the present invention, often referred to as a “tie” layer, is selected to be adhered by coextrusion to Layer C and to Layer E in the production of multilayer films of the present invention. That is, the composition of Layer D is selected so as to adhere by coextrusion to a barrier layer comprising polyamide or ethylene vinyl alcohol and to a polyolefin layer comprising polypropylene or polyethylene. In such embodiments, a bottom surface of Layer C is in adhering contact with a top surface of Layer D, and a bottom surface of Layer D is in adhering contact with a top surface of Layer E.

The selection of a composition of Layer D can depend on the composition of the barrier layer (Layer C) and the polyolefin layer (Layer E), although other factors can also be important.

In some embodiments, the composition of Layer D can be any of the compositions identified herein for Layer B (e.g., a maleic anhydride grafted copolymer comprising ethylene monomer and blends comprising same).

In some embodiments, Layer D comprises a blend of polypropylene and maleic anhydride grafted polypropylene. Examples of such blends include ADMER QF300, QB510, QB520, and QF551 commercially available from Mitsui Chemicals, Inc., and PLEXAR PX6002, PX6005 and PX6006 commercially available from LyondellBasell Industries, and Bynel 50E571, BYNEL 50E662, Bynel 50E725, Bynel 50E739, Bynel 50E803 and Bynel 50E806 commercially available from DuPont.

In some embodiments, Layer D comprises (1) a crystalline block copolymer composite (CBC) comprising i) a crystalline ethylene based polymer (CEP) comprising at least 90 mol % polymerized ethylene, ii) an alpha-olefin-based crystalline polymer (CAOP), and a block copolymer comprising (a) a crystalline ethylene block (CEB) comprising at least 90 mol % polymerized ethylene and (b) a crystalline alpha-olefin block (CAOB); (2) optionally, a polyolefin elastomer; (3) maleic anhydride grafted polyethylene (MAH-g-PE) or maleic anhydride grafted polypropylene (MAH-g-PP); and (4) optionally, polypropylene or polyethylene.

The term “crystalline block composite” (CBC) refers to polymers having three components: a crystalline ethylene based polymer (CEP) (also referred to herein as a soft polymer), a crystalline alpha-olefin based polymer (CAOP) (also referred to herein as a hard polymer), and a block copolymer comprising a crystalline ethylene block (CEB) and a crystalline alpha-olefin block (CAOB), wherein the CEB of the block copolymer is the same composition as the CEP in the block composite and the CAOB of the block copolymer is the same composition as the CAOP of the block composite. Additionally, the compositional split between the amount of CEP and CAOP will be essentially the same as that between the corresponding blocks in the block copolymer. When produced in a continuous process, the crystalline block composites desirably have a polydispersity index (PDI) from 1.7 to 15, specifically 1.8 to 10, specifically from 1.8 to 5, more specifically from 1.8 to 3.5. Such crystalline block composites are described in, for example, US Patent Application Publication Nos. 2011/0313106, 2011/0313107 and 2011/0313108, all published on Dec. 22, 2011, and in PCT Publication No. WO2014/043522A1, published Mar. 20, 2014, each of which are incorporated herein by reference with respect to descriptions of the crystalline block composites, processes to make them and methods of analyzing them.

The crystalline ethylene based polymer (CEP) comprises blocks of polymerized ethylene units in which any comonomer content is 10 mol % or less, specifically between 0 mol % and 10 mol %, more specifically between 0 mol % and 7 mol % and most specifically between 0 mol % and 5 mol %. The crystalline ethylene based polymer has corresponding melting points that are specifically 75° C. and above, specifically 90° C. and above, and more specifically 100° C. and above.

The crystalline alpha-olefin based polymer (CAOP) comprises highly crystalline blocks of polymerized alpha olefin units in which the monomer is present in an amount greater than 90 mol percent, specifically greater than 93 mol percent, more specifically greater than 95 mol percent, and specifically greater than 98 mol percent, based on the total weight of the crystalline alpha-olefin based polymer. In an exemplary embodiment, the polymerized alpha olefin unit is polypropylene. The comonomer content in the CAOPs is less than 10 mol percent, and specifically less than 7 mol percent, and more specifically less than 5 mol percent, and most specifically less than 2 mol %. CAOPs with propylene crystallinity have corresponding melting points that are 80° C. and above, specifically 100° C. and above, more specifically 115° C. and above, and most specifically 120° C. and above. In some embodiments, the CAOP comprise all or substantially all propylene units.

Examples of other alpha-olefin units (in addition to the propylene) that may be used in the CAOP contain 4 to 10 carbon atoms. Examples of these are 1-butene, 1-hexene, 4-methyl-1-pentene and 1-octene are the most preferred. Preferred diolefins are isoprene, butadiene, 1,4-pentadiene, 1,4-hexadiene, 1,5-hexadiene, 1,7-octadiene, 1, 9-decadiene, dicyclopentadiene, methylene-norbornene, 5-ethylidene-2-norbornene, or the like, or a combination comprising at least one of the foregoing alpha-olefin units.

The block copolymer of the crystalline block composite comprises an ethylene block (e.g., a crystalline ethylene block (CEB)) and a crystalline alpha olefin block (CAOB). In the crystalline ethylene block (CEB), ethylene monomer is present in an amount greater than 90 mol %, specifically greater than 93 mol percent, more specifically greater than 95 mol percent, and specifically greater than 90 mol percent, based on the total weight of the CEB. In an exemplary embodiment, the crystalline ethylene block (CEB) polymer is polyethylene. The polyethylene is present in an amount greater than 90 mol %, specifically greater than 93 mol percent, and more specifically greater than 95 mol percent, based on the total weight of the CEB. If any comonomer is present in in the CEB it is present in an amount of less than 10 mole %, specifically less than 5 mole %, based on the total number of moles of the CEB.

The CAOB comprises a polypropylene block that is copolymerized with other alpha-olefin units that contain 4 to 10 carbon atoms. Examples of the other alpha-olefin units are provided above. The polypropylene is present in the CAOB in an amount of greater than or equal to 90 mole %, specifically greater than 93 mole %, and more specifically greater than 95 mole %, based on the total number of moles of the CAOB. The comonomer content in the CAOBs is less than 10 mol percent, and specifically less than 7 mol percent, and more specifically less than 5 mol percent, based on the total number of moles in the CAOB. CAOBs with propylene crystallinity have corresponding melting points that are 80° C. and above, specifically 100° C. and above, more specifically 115° C. and above, and most specifically 120° C. and above. In some embodiments, the CAOB comprise all or substantially all propylene units.

In one embodiment, the crystalline block composite polymers comprise propylene, 1-butene or 4-methyl-1-pentene and one or more comonomers. Specifically, the block composites comprise in polymerized form propylene and ethylene and/or one or more C₄₋₂₀ α-olefin comonomers, and/or one or more additional copolymerizable comonomers or they comprise 4-methyl-1-pentene and ethylene and/or one or more C₄₋₂₀ α-olefin comonomers, or they comprise 1-butene and ethylene, propylene and/or one or more C₅-C₂₀ α-olefin comonomers and/or one or more additional copolymerizable comonomers. Additional suitable comonomers are selected from diolefins, cyclic olefins, and cyclic diolefins, halogenated vinyl compounds, and vinylidene aromatic compounds. Preferably, the monomer is propylene and the comonomer is ethylene.

Comonomer content in the crystalline block composite polymers may be measured using any suitable technique, with techniques based on nuclear magnetic resonance (NMR) spectroscopy preferred.

The crystalline block composites have a melting point Tm greater than 100° C. specifically greater than 120° C., and more specifically greater than 125° C. In an embodiment, the Tm is in the range of from 100° C. to 250° C., more specifically from 120° C. to 220° C. and also specifically in the range of from 125° C. to 220° C. Specifically the melt flow ratio (MFR) of the block composites and crystalline block composites is from 0.1 to 1000 dg/min, more specifically from 0.1 to 50 dg/min and more specifically from 0.1 to 30 dg/min.

In an embodiment, the crystalline block composites have a weight average molecular weight (Mw) from 10,000 to about 2,500,000 grams per mole (g/mole), specifically from 35000 to about 1,000,000 and more specifically from 50,000 to about 300,000, specifically from 50,000 to about 200,000 g/mole. The sum of the weight percents of soft copolymer, hard polymer and block copolymer equals 100%.

In an embodiment, the crystalline block composite polymers of the invention comprise from 0.5 to 95 wt % CEP, from 0.5 to 95 wt % CAOP and from 5 to 99 wt % block copolymer. More preferably, the crystalline block composite polymers comprise from 0.5 to 79 wt % CEP, from 0.5 to 79 wt % CAOP and from 20 to 99 wt % block copolymer and more preferably from 0.5 to 49 wt % CEP, from 0.5 to 49 wt % CAOP and from 50 to 99 wt % block copolymer. Weight percents are based on total weight of crystalline block composite. The sum of the weight percents of CEP, CAOP and block copolymer equals 100%.

Preferably, the block copolymers of the invention comprise from 5 to 95 weight percent crystalline ethylene blocks (CEB) and 95 to 5 wt percent crystalline alpha-olefin blocks (CAOB). They may comprise 10 wt % to 90 wt % CEB and 90 wt % to 10 wt % CAOB. More preferably, the block copolymers comprise 25 to 75 wt % CEB and 75 to 25 wt % CAOB, and even more preferably they comprise 30 to 70 wt % CEB and 70 to 30 wt % CAOB.

In some embodiments, the crystalline block composites have a Crystalline Block Composite Index (CBCI) that is greater than zero but less than about 0.4 or from 0.1 to 0.3. In other embodiments, CBCI is greater than 0.4 and up to 1.0. In some embodiments, the CBCI is 0.1 to 0.9, from about 0.1 to about 0.8, from about 0.1 to about 0.7 or from about 0.1 to about 0.6. Additionally, the CBCI can be in the range of from about 0.4 to about 0.7, from about 0.5 to about 0.7, or from about 0.6 to about 0.9. In some embodiments, CBCI is in the range of from about 0.3 to about 0.9, from about 0.3 to about 0.8, or from about 0.3 to about 0.7, from about 0.3 to about 0.6, from about 0.3 to about 0.5, or from about 0.3 to about 0.4. In other embodiments, CBCI is in the range of from about 0.4 to about 1.0, from about 0.5 to about 1.0, or from about 0.6 to about 1.0, from about 0.7 to about 1.0, from about 0.8 to about 1.0, or from about 0.9 to about 1.0.

Information regarding the method of making crystalline block composites for use in some embodiments of the present invention is provided in Example 2 below.

As noted above, in embodiments where Layer D comprises a CBC, Layer D may further comprise (1) optionally, a polyolefin elastomer; (2) maleic anhydride grafted polyethylene (MAH-g-PE) or maleic anhydride grafted polypropylene (MAH-g-PP); and (3) optionally, polypropylene or polyethylene.

The components of Layer D may be present in the following amounts based on the total polymer weight of Layer D: 20 wt % to 90 wt %, preferably 40-60 wt % CBC; optionally 0 wt % to 30 wt %, preferably 10 wt % to 30 wt % polyolefin elastomer; 10 wt % to 30 wt % maleic anhydride grafted polyethylene (MAH-g-PE); and, optionally, 0 wt % to 20 wt %, polypropylene or 0 wt % to 20 wt %, polyethylene. The grafted MAH concentration in Layer D formulation can range from 0.05 to 1.0%. Optionally, MAH-g-PE can be substituted by maleic anhydride grafted polypropylene (MAH-g-PP) or a combination of MAH-g-PE and MAH-g-PP.

When the tie layer (Layer D) formulation comprises a polyolefin elastomer, suitable polyolefin elastomers include any polyethylene or polypropylene based elastomer including homogeneously branched ethylene/alpha-olefin copolymer, propylene/alpha-olefin interpolymer, and ethylene-propylene-diene monomer rubber (EPDM).

The homogeneously branched ethylene/alpha-olefin copolymer can be made with a single-site catalyst such as a metallocene catalyst or constrained geometry catalyst, and typically have a melting point of less than 105, preferably less than 90, more preferably less than 85, even more preferably less than 80 and still more preferably less than 75° C. The melting point is measured by differential scanning calorimetry (DSC) as described, for example, in U.S. Pat. No. 5,783,638. The α-olefin is preferably a C₃₋₂₀ linear, branched or cyclic α-olefin. Examples of C₃₋₂₀ α-olefins include propene, 1-butene, 4-methyl-1-pentene, 1-hexene, 1-octene, 1-decene, 1-dodecene, 1-tetradecene, 1-hexadecene, and 1-octadecene. The α-olefins can also contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, for purposes of this invention certain cyclic olefins, such as norbornene and related olefins, are α-olefins and can be used in place of some or all of the α-olefins described above. Similarly, styrene and its related olefins (for example, α-methylstyrene, etc.) are α-olefins for purposes of this invention. Illustrative homogeneously branched ethylene/alpha-olefin copolymers include ethylene/propylene, ethylene/butene, ethylene/1-hexene, ethylene/1-octene, ethylene/styrene, and the like. Illustrative terpolymers include ethylene/propylene/1-octene, ethylene/propylene/butene, ethylene/butene/1-octene, and ethylene/butene/styrene. The copolymers can be random or blocky.

More specific examples of homogeneously branched ethylene/alpha-olefin interpolymers useful in this invention include homogeneously branched, linear ethylene/α-olefin copolymers (e.g. TAFMER® by Mitsui Petrochemicals Company Limited and EXACT® by Exxon Chemical Company), and the homogeneously branched, substantially linear ethylene/α-olefin polymers (e.g., AFFINITY™ and ENGAGE™ polyethylene available from The Dow Chemical Company). The substantially linear ethylene copolymers are especially preferred, and are more fully described in U.S. Pat. Nos. 5,272,236, 5,278,272 and 5,986,028. Blends of any of these interpolymers can also be used in the practice of this invention. In the context of this invention, homogeneously branched ethylene/alpha-olefin interpolymers are not olefin block copolymers.

The polypropylene that can be used optionally in tie Layer D, can be homopolymer (hPP), random copolymer polypropylene (rcPP), impact copolymer polypropylene (hPP+at least one elastomeric impact modifier) (ICPP) or high impact polypropylene (HIPP), high melt strength polypropylene (HMS-PP), isotactic polypropylene (iPP), syndiotactic polypropylene (sPP), and combinations thereof.

The polypropylene that can be used optionally in tie Layer D, can also be a propylene-alpha-olefin interpolymer. The propylene-alpha-olefin interpolymer is characterized as having substantially isotactic propylene sequences. The propylene-alpha-olefin interpolymers include propylene-based elastomers (PBE). “Substantially isotactic propylene sequences” means that the sequences have an isotactic triad (mm) measured by ¹³C NMR of greater than 0.85; in the alternative, greater than 0.90; in another alternative, greater than 0.92; and in another alternative, greater than 0.93. Isotactic triads are well-known in the art and are described in, for example, U.S. Pat. No. 5,504,172 and International Publication No. WO 00/01745, which refers to the isotactic sequence in terms of a triad unit in the copolymer molecular chain determined by ¹³C NMR spectra.

The propylene/alpha-olefin interpolymer may have a melt flow rate in the range of from 0.1 to 500 grams per 10 minutes (g/10 min), measured in accordance with ASTM D-1238 (at 230° C./2.16 Kg). All individual values and subranges from 0.1 to 500 g/10 min are included herein and disclosed herein; for example, the melt flow rate can be from a lower limit of 0.1 g/10 min, 0.2 g/10 min, or 0.5 g/10 min to an upper limit of 500 g/10 min, 200 g/10 min, 100 g/10 min, or 25 g/10 min. For example, the propylene/alpha-olefin copolymer may have a melt flow rate in the range of from 0.1 to 200 g/10 min; or in the alternative, the propylene/alpha-olefin copolymer may have a melt flow rate in the range of from 0.2 to 100 g/10 min; or in the alternative, the propylene/alpha-olefin copolymer may have a melt flow rate in the range of from 0.2 to 50 g/10 min; or in the alternative, the propylene/alpha-olefin copolymer may have a melt flow rate in the range of from 0.5 to 50 g/10 min; or in the alternative, the propylene/alpha-olefin copolymer may have a melt flow rate in the range of from 1 to 50 g/10 min; or in the alternative, the propylene/alpha-olefin copolymer may have a melt flow rate in the range of from 1 to 40 g/10 min; or in the alternative, the propylene/alpha-olefin interpolymer may have a melt flow rate in the range of from 1 to 30 g/10 min.

The propylene/alpha-olefin interpolymer has crystallinity in the range of from at least 1 percent by weight (a heat of fusion (H_{f}) of at least 2 Joules/gram (J/g)) to 30 percent by weight (a H_{f} of less than 50 J/g). All individual values and subranges from 1 percent by weight (a H_{f} of at least 2 J/g) to 30 percent by weight (a H_{f} of less than 50 J/g) are included herein and disclosed herein; for example, the crystallinity can be from a lower limit of 1 percent by weight (a H_{f} of at least 2 J/g), 2.5 percent (a H_{f} of at least 4 J/g), or 3 percent (a H_{f} of at least 5 J/g) to an upper limit of 30 percent by weight (a H_{f} of less than 50 J/g), 24 percent by weight (a H_{f} of less than 40 J/g), 15 percent by weight (a H_{f} of less than 24.8 J/g) or 7 percent by weight (a H_{f} of less than 11 J/g). For example, the propylene/alpha-olefin copolymer may have a crystallinity in the range of from at least 1 percent by weight (a H_{f} of at least 2 J/g) to 24 percent by weight (a H_{f} of less than 40 J/g); or in the alternative, the propylene/alpha-olefin copolymer may have a crystallinity in the range of from at least 1 percent by weight (a H_{f} of at least 2 J/g to 15 percent by weight (a H_{f} of less than 24.8 J/g); or in the alternative, the propylene/alpha-olefin copolymer may have a crystallinity in the range of from at least 1 percent by weight (a H_{f} of at least 2 J/g) to 7 percent by weight (a H_{f} of less than 11 J/g); or in the alternative, the propylene/alpha-olefin copolymer may have a crystallinity in the range of H_{f} of less than 8.3 J/g). The crystallinity is measured by differential scanning calorimetry (DSC) as described in U.S. Pat. No. 7,199,203. The propylene/alpha-olefin copolymer comprises units derived from propylene and polymeric units derived from one or more alpha-olefin comonomers. Exemplary comonomers utilized to manufacture the propylene/alpha-olefin copolymer are C₂ and C₄ to C₁₀ alpha-olefins; for example, C₂, C₄, C₆ and C₈ alpha-olefins.

The propylene/alpha-olefin interpolymer comprises from 1 to 40 percent by weight of one or more alpha-olefin comonomers. All individual values and subranges from 1 to 40 weight percent are included herein and disclosed herein; for example, the comonomer content can be from a lower limit of 1 weight percent, 3 weight percent, 4 weight percent, 5 weight percent, 7 weight percent, or 9 weight percent to an upper limit of 40 weight percent, 35 weight percent, 30 weight percent, 27 weight percent, 20 weight percent, 15 weight percent, 12 weight percent, or 9 weight percent. For example, the propylene/alpha-olefin copolymer comprises from 1 to 35 percent by weight of one or more alpha-olefin comonomers; or in the alternative, the propylene/alpha-olefin copolymer comprises from 1 to 30 percent by weight of one or more alpha-olefin comonomers; or in the alternative, the propylene/alpha-olefin copolymer comprises from 3 to 27 percent by weight of one or more alpha-olefin comonomers; or in the alternative, the propylene/alpha-olefin copolymer comprises from 3 to 20 percent by weight of one or more alpha-olefin comonomers; or in the alternative, the propylene/alpha-olefin copolymer comprises from 3 to 15 percent by weight of one or more alpha-olefin comonomers.

The propylene/alpha-olefin interpolymer has a density of typically less than 0.895 g/cm³; or in the alternative, less than 0.890 g/cm³; or in the alternative, less than 0.880 g/cm³; or in the alternative, less than 0.870 g/cm³. The propylene/alpha-olefin interpolymer has a density of typically greater than 0.855 g/cm³; or in the alternative, greater than 0.860 g/cm³; or in the alternative, greater than 0.865 g/cm³.

The propylene/alpha-olefin interpolymer has a melting temperature (Tm) typically of less than 120° C.; or in the alternative, <100° C.; or in the alternative, <90° C.; or in the alternative, <80° C.; or in the alternative, <70° C.; and a heat of fusion (H_{f}) typically of less than 70 Joules per gram (J/g) as measured by differential scanning calorimetry (DSC) as described in U.S. Pat. No. 7,199,203.

The propylene/alpha-olefin interpolymer has a molecular weight distribution (MWD), defined as weight average molecular weight divided by number average molecular weight (M_{w}/Mₙ) of 3.5 or less; or 3.0 or less; or from 1.8 to 3.0.

Such propylene/alpha-olefin interpolymers are further described in the U.S. Pat. Nos. 6,960,635 and 6,525,157. Such propylene/alpha-olefin interpolymers are commercially available from The Dow Chemical Company, under the trade name VERSIFY, or from ExxonMobil Chemical Company, under the trade name VISTAMAXX.

The polypropylene that can be used optionally in tie Layer D can also be EPDM materials. EPDM materials are linear interpolymers of ethylene, propylene, and a nonconjugated diene such as 1,4-hexadiene, dicyclopentadiene, or ethylidene norbornene. A preferred class of interpolymers having the properties disclosed herein is obtained from polymerization of ethylene, propylene, and a non-conjugated diene to make an EPDM elastomer. Suitable non-conjugated diene monomers can be a straight chain, branched chain or cyclic hydrocarbon diene having from 6 to 15 carbon atoms. Examples of suitable non-conjugated dienes include, but are not limited to, straight chain acyclic dienes, such as 1,4-hexadiene, 1,6-octadiene, 1,7-octadiene, 1,9-decadiene, branched chain acyclic dienes, such as 5-methyl-1,4-hexadiene; 3,7-dimethyl-1,6-octadiene; 3,7-dimethyl-1,7-octadiene and mixed isomers of dihydromyricene and dihydroocinene, single ring alicyclic dienes, such as 1,3-cyclopentadiene; 1,4-cyclohexadiene; 1,5-cyclooctadiene and 1,5-cyclododecadiene, and multi-ring alicyclic fused and bridged ring dienes, such as tetrahydroindene, methyl tetrahydroindene, dicyclopentadiene, bicyclo-(2,2,1)-hepta-2,5-diene; alkenyl, alkylidene, cycloalkenyl and cycloalkylidene norbornenes, such as 5-methylene-2-norbornene (MNB); 5-propenyl-2-norbornene, 5-isopropylidene-2-norbornene, 5-(4-cyclopentenyl)-2-norbornene, 5-cyclohexylidene-2-norbornene, 5-vinyl-2-norbornene, and norbornadiene. Of the dienes typically used to prepare EPDMs, the particularly preferred dienes are 1,4-hexadiene (HD), 5-ethylidene-2-norbornene (ENB), 5-vinylidene-2-norbornene (VNB), 5-methylene-2-norbornene (MNB), and dicyclopentadiene (DCPD). The especially preferred dienes are 5-ethylidene-2-norbornene (ENB) and 1,4-hexadiene (HD).

In some embodiments, the EPDM polymers have an ethylene content of from 50% to 75% by weight, a propylene content of from 20% to 49% by weight, and a nonconjugated diene content from 1% to 10% by weight, all weights based upon the total weight of the polymer. Examples of representative EPDM polymers for use include Nordel IP 4770R, Nordel 3722 IP available from The Dow Chemical Company, Midland, Mich., Vistalon 3666 available from ExxonMobil, Baton Rouge, La., and Keltan 5636A available from DSM Elastomers Americas, Addis, La.

The EPDM polymers, also known as elastomeric copolymers of ethylene, a higher-alpha-olefin and a polyene, have molecular weights from 20,000 to 2,000,000 Daltons or more. Their physical form varies from waxy materials to rubbers to hard plastic-like polymers. They have dilute solution viscosities (DSV) from 0.5 to 10 dl/g, measured at 30° C. on a solution of 0.1 gram of polymer in 100 cc of toluene. The EPDM polymers also have a Mooney viscosity of greater than 50 ML (1+4) at 125° C.; and, a density of 0.870 g/cc to 0.885 g/cc or from 0.875 g/cc to 0.885 elm

The polyethylene optionally used in tie Layer D is selected from ultralow density polyethylene (ULDPE), low density polyethylene (LDPE), linear low density polyethylene (LLDPE), medium density polyethylene (MOPE), high density polyethylene (HDPE), high melt strength high density polyethylene (HMS-HDPE), ultrahigh density polyethylene (UHDPE), and combinations thereof. In a further embodiment, the polyethylene has a density greater than 0.950 g/cc (i.e., a HDPE).

The MAH-g-PE used in any of the tie layers is a maleic anhydride grafted polyethylene. The grafted polyethylene may be any of the polyethylenes as described above. The amount of maleic anhydride constituent grafted onto the polyethylene chain is greater than 0.05 weight percent to 2.0 wt percent (based on the weight of the olefin interpolymer), as determined by titration analysis, FTIR analysis, or any other appropriate method. More preferably, this amount is greater than 0.25 weight percent to 2.0 weight percent, and in yet a further embodiment, this amount is greater than 0.3 weight percent to 2.0 weight percent. In a preferred embodiment, 0.5 weight percent to 2.0 weight percent of maleic anhydride is grafted.

The graft process for MAH-g-PE can be initiated by decomposing initiators to form free radicals, including azo-containing compounds, carboxylic peroxyacids and peroxyesters, alkyl hydroperoxides, and dialkyl and diacyl peroxides, among others. Many of these compounds and their properties have been described (Reference: J. Branderup, E. Immergut, E. Grulke, eds. “Polymer Handbook,” 4th ed., Wiley, New York, 1999, Section II, pp. 1-76.). It is preferable for the species that is formed by the decomposition of the initiator to be an oxygen-based free radical. It is more preferable for the initiator to be selected from carboxylic peroxyesters, peroxyketals, dialkyl peroxides, and diacyl peroxides. Some of the more preferable initiators, commonly used to modify the structure of polymers, are listed in U.S. Pat. No. 7,897,689, in the table spanning Col. 48 line 13—Col. 49 line 29, which is hereby incorporated by reference. Alternatively, the grafting process for MAH-g-PE can be initiated by free radicals generated by thermal oxidative process.

Optionally, a MAH-g-PP concentrate may be used. The grafted polypropylene may be any of the polypropylenes as described for Layer E. The amount of maleic anhydride constituent grafted onto the polypropylene chain is greater than 0.05 weight percent to 2.0 wt percent (based on the weight of the olefin interpolymer), as determined by titration analysis, FTIR analysis, or any other appropriate method. More preferably, this amount is greater than 0.25 weight percent to 2.0 weight percent, and in yet a further embodiment, this amount is greater than 0.3 weight percent to 2.0 weight percent. In a preferred embodiment, 0.5 weight percent to 2.0 weight percent of maleic anhydride is grafted.

Optionally, MAH-g-PE can be replaced or combined with a variety of grafted polyolefins that comprising radically graftable species. These species include unsaturated molecules, each containing at least one heteroatom. These species include, but are not limited to, maleic anhydride, dibutyl maleate, dicyclohexyl maleate, diisobutyl maleate, dioctadecyl maleate, N-phenylmaleimide, citraconic anhydride, tetrahydrophthalic anhydride, bromomaleic anhydride, chloromaleic anhydride, nadic anhydride, methylnadic anhydride, alkenylsuccinic anhydride, maleic acid, fumaric acid, diethyl fumarate, itaconic acid, citraconic acid, crotonic acid, and the respective esters, imides, salts, and Diels-Alder adducts of these compounds.

### Other Layers

Some embodiments of multilayer films of the present invention can include layers beyond those described above.

For example, in some embodiments, a multilayer film can comprise one or more layers between Layer B and Layer C. In some embodiments, a multilayer film comprising Layers A-E as described above can further comprise Layers F and G, with a top facial surface of Layer F being in adhering contact with a bottom facial surface of Layer B, and with a top facial surface of Layer G being in adhering contact with a bottom facial surface of Layer F. In some such embodiments, Layer F can comprise polypropylene and Layer G can comprise a tie layer. When Layer F is polypropylene, the polypropylene can be any of those described above in connection with Layer E, and the tie layer can be any of those described above in connection with Layer D. An additional layer of polypropylene and the associated tie layer might be provided, for example, to add further structural support to the film.

Other film layers can also be included in other embodiments. For example, one or more layers can be provided adjacent to Layer B. As another example, depending on the application, multiple barrier layers can be included within the multilayer film. For example, in some embodiments, a multilayer film comprising Layers A-E as described above can further comprise Layers F and G, with a top facial surface of Layer F being in adhering contact with a bottom facial surface of Layer B, and with a top facial surface of Layer G being in adhering contact with a bottom facial surface of Layer F. In some such embodiments, Layer F can comprise polyamide, Layer G can comprise ethylene vinyl alcohol, and Layer C can comprise polyamide to form a three layer (F/G/C) barrier structure within the multilayer film of polyamide/ethylene vinyl alcohol/polyamide.

### Additives

It should be understood that any of the foregoing layers can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

### Methods of Preparing Multilayer Films

Multilayer films comprising the combinations of layers disclosed herein can advantageously be prepared in a single coextrusion step. For example, multilayer films of the present invention can be blown films or cast films. The ability to prepare the multilayer films in a single coextrusion step is particularly advantageous where such films are to be used in aseptic packaging applications as such films traditionally require multiple processing steps (e.g., extrusion of multiple films followed by a lamination step and curing). Thus, multilayer films of the present invention can advantageously be prepared in a single coextrusion step while also providing one or more properties desirable for aseptic packaging applications.

Multilayer films can be coextruded as blown films or cast films using techniques known to those of skill in the art based on the teachings herein. In particular, based on the compositions of the different film layers disclosed herein, blown film manufacturing lines and cast film manufacturing lines can be configured to coextrude multilayer films of the present invention in a single extrusion step using techniques known to those of skill in the art based on the teachings herein.

### Multilayer Films and Packages

Multilayer films comprising the combinations of layers disclosed herein can have a variety of thicknesses depending, for example, on the number of layers, the intended use of the film, and other factors. In some embodiments, multilayer films of the present invention have a thickness of 15 microns to 2.5 centimeters. Multilayer films of the present invention, in some embodiments, have a thickness of 20 to 500 microns (preferably 50-200 microns). Multilayer films of the present invention can exhibit one or more desirable properties. For example, in some embodiments, multilayer films can exhibit desirable peel strength (greater 3 N/15 mm, preferably greater 4.5 N/15 mm, when measured according to ISO 11339), barrier properties, temperature resistance, optical properties, stiffness, resistance to sterilizing agents such as hydrogen peroxide and others. In some embodiments, multilayer films can exhibit properties making them desirable for use in aseptic liquid packages and/or sterilizable packages for medical products. For such uses, multilayer films need to be resistant to temperature during processing/packaging while maintaining desirable barrier properties, peel strength, and other physical properties.

Multilayer films of the present invention can be formed into aseptic packages using techniques known to those of skill in the art. In some embodiments, the aseptic package can include a liquid. Examples of liquids that can be used in aseptic packages include, without limitation, fruit juice, tea, milk, yogurt, and others. Multilayer films of the present invention can also be formed into medical packages that can be subject to sterilization in some embodiments.

In one embodiment of a method of preparing a multilayer film comprising at least five layers, wherein the layers are arranged in the order A/B/C/D/E, the method comprises:

coextruding Layer A, Layer B, Layer C, Layer D, and Layer E, such that a top facial surface of Layer B is in adhering contact with a bottom facial surface of Layer A, a top facial surface of Layer C is in adhering contact with a bottom facial surface of Layer B, a top facial surface of Layer D is in adhering contact with a bottom facial surface of Layer C, and a top facial surface of Layer E is in adhering contact with a bottom facial surface of Layer D;

wherein:

Layer A comprises polyethylene terephthalate (PET);

Layer B comprises a maleic anhydride grafted polymer comprising ethylene monomer;

Layer C comprises polyamide or ethylene vinyl alcohol;

Layer D comprises either:
(2) a maleic anhydride grafted polymer comprising ethylene monomer, or
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene; and

Layer E comprises polypropylene or polyethylene, a top facial surface of Layer E being in adhering contact with a bottom facial surface of Layer D.

In one embodiment of a method of preparing a multilayer film comprising at least seven layers, wherein the layers are arranged in the order A/B/C/D/E/F/G, the method comprises:

coextruding Layer A, Layer B, Layer C, Layer D, Layer E, Layer F, and Layer G such that a top facial surface of Layer B is in adhering contact with a bottom facial surface of Layer A, a top facial surface of Layer C is in adhering contact with a bottom facial surface of Layer B, a top facial surface of Layer D is in adhering contact with a bottom facial surface of Layer C, and a top facial surface of Layer E is in adhering contact with a bottom facial surface of Layer D, a top facial surface of Layer F is in adhering contact with a bottom facial surface of Layer E, a top facial surface of Layer G is in adhering contact with a bottom facial surface of Layer F;

wherein:

Layer A comprises polyethylene terephthalate (PET);

Layer B comprises a maleic anhydride grafted polymer comprising ethylene monomer;

Layer C comprises polypropylene;

Layer D comprises either:
(2) a maleic anhydride grafted polymer comprising ethylene monomer, or
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene;

Layer E comprises polyamide or ethylene vinyl alcohol;

Layer F comprises either:
(1) a maleic anhydride grafted polymer comprising ethylene monomer, or
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene; and

Layer G comprises polypropylene or polyethylene.

In one embodiment, a method of preparing a multilayer film comprising at least seven layers, wherein the layers are arranged in the order A/B/C/D/E/F/G, the method comprises:

coextruding Layer A, Layer B, Layer C, Layer D, Layer E, Layer F, and Layer G such that a top facial surface of Layer B is in adhering contact with a bottom facial surface of Layer A, a top facial surface of Layer C is in adhering contact with a bottom facial surface of Layer B, a top facial surface of Layer D is in adhering contact with a bottom facial surface of Layer C, and a top facial surface of Layer E is in adhering contact with a bottom facial surface of Layer D, a top facial surface of Layer F is in adhering contact with a bottom facial surface of Layer E, a top facial surface of Layer G is in adhering contact with a bottom facial surface of Layer F;

wherein:

Layer A comprises polyethylene terephthalate (PET);

Layer B comprises a maleic anhydride grafted polymer comprising ethylene monomer;

Layer C comprises polyamide;

Layer D comprises ethylene vinyl alcohol;

Layer E comprises polyamide;

Layer F comprises either:
(1) a maleic anhydride grafted polymer comprising ethylene monomer, or
(2) a) a crystalline block copolymer composite (CBC) comprising:
   i) a crystalline ethylene based polymer (CEP) comprising at least 90 mol % polymerized ethylene;
   ii) an alpha-olefin-based crystalline polymer (CAOP); and
   iii) a block copolymer comprising (a) a crystalline ethylene block (CEB) comprising at least 90 mol % polymerized ethylene and (b) a crystalline alpha-olefin block (CAOB);
   b) optionally, a polyolefin elastomer;
   c) maleic anhydride grafted polyethylene (MAH-g-PE) or maleic anhydride grafted polypropylene (MAH-g-PP); and
   d) optionally, polypropylene or polyethylene, or
(3) a blend of polypropylene and maleic anhydride grafted polypropylene; and

Layer G comprises polypropylene or polyethylene.

Similar methods will be apparent to those of skill in the art based on the different combinations of layers of the multilayer film disclosed herein.

Some embodiments of the invention will now be described in detail in the following Examples.

### EXAMPLES

### Example 1

In this Example, a film (Inventive Example 1) is produced on a 7-layer Collin blown film line using conventional blown film manufacturing conditions. Table 1 shows the line settings used during the experiment:

TABLE 1

| | Extruder A | | | | | | |
|---|---|---|---|---|---|---|---|
| | Cumastretch | Extruder B | Extruder C | Extruder D | Extruder E | Extruder F | Extruder G |
| resin | FX | Tie layer | Inspire 361 | Tie Layer | UBE 5034B | Tie layer | Inspire 361 |
| Inlet Temp. | 50 | 40 | 40 | 40 | 40 | 40 | 40 |
| (° C.) | | | | | | | |
| cylinder 1 | 255 | 210 | 180 | 210 | 230 | 210 | 180 |
| Temp. (° C.) | | | | | | | |
| Cylinder 2 | 260 | 230 | 230 | 230 | 250 | 230 | 230 |
| Temp. (° C.) | | | | | | | |
| Cylinder 3 | 250 | 240 | 240 | 240 | 250 | 240 | 240 |
| Temp. (° C.) | | | | | | | |
| Cylinder 4 | 250 | | | | | | 240 |
| Temp. (° C.) | | | | | | | |
| c-flange | | | 240 | 240 | 250 | | |
| Temp. (° C.) | | | | | | | |
| Adaptor 1 | 250 | 240 | 240 | 240 | 240 | 240 | 240 |
| Temp. (° C.) | | | | | | | |
| Adaptor 2 | 250 | 240 | 240 | 240 | 240 | 240 | 240 |
| Temp. (° C.) | | | | | | | |
| Screw | 24 | 40 | 56 | 40 | 59 | 40 | 48 |
| (rpm) | | | | | | | |
| m-current | 1.0 | 1.1 | 3.1 | 1.2 | 3.9 | 1.1 | 1.9 |
| (A) | | | | | | | |
| Melt temp. | 237 | 220 | 243 | 245 | 243 | 230 | 227 |
| (° C.) | | | | | | | |
| Melt press. | 45 | 72 | 185 | 65 | 157 | 85 | 131 |
| (bar) | | | | | | | |
| Feeding | 1.526 | 0.961 | 1.696 | 0.909 | 2.265 | 0.917 | 1.999 |
| (kg/h) | | | | | | | |

Die temperature settings: 230-240° C.
Feeding: 10.3 kg/h
Take-off: 3.5 m/minute

The film has the following layer structure: PET/Tie Layer/PP/Tie/PA/Tie/PP with relative layer thicknesses of 11%/6%/25%/6%/20%/6%/26%. The film has a nominal thickness of 100 microns. The PET layer in the film is Cumastretch FX polyethylene terephthalate commercially available from DuFor Resins BV. The PP layers in the film are INSPIRE 361 polypropylene commercially available from Braskem S.A. The PA layer in the film is UBE 5034B polyamide commercially available from UBE America Inc. The tie layer is a blend of 30 wt % AMPLIFY TY 1052H, 35 wt % AMPLIFY EA 100, and 35 wt % AMPLIFY EA 101, each of which are commercially available from The Dow Chemical Company. The inner polypropylene layer and the PET skin layer act as structural layers to provide stiffness, and the outer polypropylene layer acts as a sealant layer. The polyamide layer acts as a gas barrier layer.

The peel strength between the PET layer and the PP layer in the film is measured according to the following method. Test specimens are cut having the dimension 200 mm×15 mm. The film is prestretched at one end of a 15 mm wide test strip. The film is then incubated in isopropanol (at a temperature of ˜40° C.). After 5 minutes of incubation, delamination of the PET layer is initiated. 3-4 centimeters of the PET layer is peeled off to allow the PET film layer to be clamped into the jaws of the tensile tester machine. The other unbonded film is clamped into the other jaw of the machine. The film is dried before the measurement. The peel force is measured according to ISO 11339 using a Zwicki Z2.5 Tensile Testing Machine at a constant cross head rate of 100 mm/min at standard settings for measuring peel force. The average measured peel force of Inventive Example 1 is 4.64 N/15 mm.

### Example 2

In this example, different tie layers are formulated and evaluated for seal strength with glycol modified polyethylene terephthalate (PETG) and with homopolymer polypropylene. The raw materials used in this Example are shown in Table 2:

TABLE 2

| Material | Description |
|---|---|
| CBC1 | olefin block copolymer available from The Dow Chemical |
| | Company |
| MAH-g-HDPE | maleic anhydride grafted high density polyethylene (AMPLIFY |
| | TY1053H from The Dow Chemical Company) |
| Lotader 8840 | random copolymer of ethylene and glycidyl methacrylate (8% |
| | glycidyl methacrylate content; I₂ = 5 g/10 minutes @ 190° C.) |
| | (Lotader 8840 from Arkema) |
| Igetabond E | random copolymer of ethylene and glycidyl methacrylate (12% |
| | glycidyl methacrylate; I₂ = 3 g/10 minutes @ 190° C.) (Igetabond |
| | E from Sumika Polymers) |
| ENGAGE 8130 | polyolefin elastomer (ethylene-octene copolymer) (density of |
| | 0.864 g/cm³ and I₂ of 13 g/10 minutes @ 190° C.) (ENGAGE |
| | 8130 from The Dow Chemical Company) |
| PETG | glycol modified polyethylene terephthalate (Embrace ® LV |
| | Copolyester from Eastman Chemical Company) |
| Adstif HA802H | high crystallinity polypropylene (I₂ of 2.3 g/10 minutes @230° C.) |
| | (Adstif HA802H from LyondellBasell Industries) |
| Irganox B225 | anti-oxidant (Iraganox B225 from BASF) |

CBC1 is an olefin block copolymer, also referred to as a crystalline block composite, that includes 50 wt % of an ethylene-propylene copolymer (having an ethylene content of 92 wt %) and 50 wt % of isotactic polypropylene.

CBC1, as well as other crystalline block composite polymers that can be used in embodiments of the present invention, may be prepared by a process comprising contacting an addition polymerizable monomer or mixture of monomers under addition polymerization conditions with a composition comprising at least one addition polymerization catalyst, at least one cocatalyst, and a chain shuttling agent, said process being characterized by formation of at least some of the growing polymer chains under differentiated process conditions in two or more reactors operating under steady state polymerization conditions or in two or more zones of a reactor operating under plug flow polymerization conditions. The term, “shuttling agent” refers to a compound or mixture of compounds that is capable of causing polymeryl exchange between at least two active catalyst sites under the conditions of the polymerization. That is, transfer of a polymer fragment occurs both to and from one or more of the active catalyst sites. In contrast to a shuttling agent, a “chain transfer agent” causes termination of polymer chain growth and amounts to a one-time transfer of growing polymer from the catalyst to the transfer agent. In a preferred embodiment, the crystalline block composites comprise a fraction of block polymer which possesses a most probable distribution of block lengths.

Suitable processes useful in producing CBC1 and other crystalline block composites may be found, for example, in U.S. Patent Application Publication No. 2008/0269412, published on Oct. 30, 2008. In particular, the polymerization is desirably carried out as a continuous polymerization, preferably a continuous, solution polymerization, in which catalyst components, monomers, and optionally solvent, adjuvants, scavengers, and polymerization aids are continuously supplied to one or more reactors or zones and polymer product continuously removed therefrom. Within the scope of the terms “continuous” and “continuously” as used in this context are those processes in which there are intermittent additions of reactants and removal of products at small regular or irregular intervals, so that, over time, the overall process is substantially continuous. The chain shuttling agent(s) may be added at any point during the polymerization including in the first reactor or zone, at the exit or slightly before the exit of the first reactor, or between the first reactor or zone and the second or any subsequent reactor or zone. Due to the difference in monomers, temperatures, pressures or other difference in polymerization conditions between at least two of the reactors or zones connected in series, polymer segments of differing composition such as comonomer content, crystallinity, density, tacticity, regio-regularity, or other chemical or physical difference, within the same molecule are formed in the different reactors or zones. The size of each segment or block is determined by continuous polymer reaction conditions, and preferably is a most probable distribution of polymer sizes.

When producing a block polymer having a crystalline ethylene block (CEB) and a crystalline alpha-olefin block (CAOB) in two reactors or zones it is possible to produce the CEB in the first reactor or zone and the CAOB in the second reactor or zone or to produce the CAOB in the first reactor or zone and the CEB in the second reactor or zone. It may be more advantageous to produce CEB in the first reactor or zone with fresh chain shuttling agent added. The presence of increased levels of ethylene in the reactor or zone producing CEB may lead to much higher molecular weight in that reactor or zone than in the zone or reactor producing CAOB. The fresh chain shuttling agent will reduce the MW of polymer in the reactor or zone producing CEB thus leading to better overall balance between the length of the CEB and CAOB segments.

When operating reactors or zones in series it is necessary to maintain diverse reaction conditions such that one reactor produces CEB and the other reactor produces CAOB. Carryover of ethylene from the first reactor to the second reactor (in series) or from the second reactor back to the first reactor through a solvent and monomer recycle system is preferably minimized. There are many possible unit operations to remove this ethylene, but because ethylene is more volatile than higher alpha olefins one simple way is to remove much of the unreacted ethylene through a flash step by reducing the pressure of the effluent of the reactor producing CEB and flashing off the ethylene. An exemplary approach is to avoid additional unit operations and to utilize the much greater reactivity of ethylene versus higher alpha olefins such that the conversion of ethylene across the CEB reactor approaches 100%. The overall conversion of monomers across the reactors can be controlled by maintaining the alpha olefin conversion at a high level (90 to 95%).

Exemplary catalysts and catalyst precursors for use to from the crystalline block composite include metal complexes such as disclosed in, e.g., International Publication No WO 2005/090426. Other exemplary catalysts are also disclosed in U.S. Patent Publication Nos. 2006/0199930, 2007/0167578, and 2008/0311812; U.S. Pat. No. 7,355,089; and International Publication No. WO 2009/012215.

The crystalline block composite (CBC1) is characterized as appropriate by Differential Scanning calorimetry (DSC), C¹³ Nuclear Magnetic Resonance (NMR), Gel Permeation Chromatography (GPC), and high temperature liquid chromatography (HTLC) fractionation. These are described in more detail in US Patent Application Publication Nos US2011-0082257, US2011-0082258 and US2011-0082249, all published on Apr. 7, 2011 and are incorporated herein by reference with respect to descriptions of the analysis methods.

The measured properties of CBC1 are provided in Table 3, below.

TABLE 3

| | | wt % PP | | | Total | | | | Crystalline |
|---|---|---|---|---|---|---|---|---|---|
| | MFR | from | | | wt % | Tm (° C.) | | Melt | Block |
| | (230° C./ | HTLC | Mw | Mw/ | C₂ | Peak 1 | Tc | Enthalpy | Composite |
| Material | 2.16 kg) | Separation | Kg/mol | Mn | (NMR) | (Peak 2) | (° C.) | (J/g) | Index |
| CBC1 | 9.8 | 19.9 | 103.6 | 2.73 | 47.6 | 107.9 (130.0) | 87.8 | 95 | 0.549 |

### Crystalline Block Composite Index Calculations

CBCI provides an estimate of the quantity of block copolymer within the block composite under the assumption that the ratio of CEB to CAOB within the diblock is the same as the ratio of ethylene to alpha-olefin in the overall block composite. This assumption is valid for these statistical olefin block copolymers based on the understanding of the individual catalyst kinetics and the polymerization mechanism for the formation of the diblocks via chain shuttling catalysis as described in the specification. This CBCI analysis shows that the amount of isolated PP is less than if the polymer was a simple blend of a propylene homopolymer (in this example the CAOP) and polyethylene (in this example the CEP). Consequently, the polyethylene fraction contains an appreciable amount of propylene that would not otherwise be present if the polymer was simply a blend of polypropylene and polyethylene. To account for this “extra propylene”, a mass balance calculation can be performed to estimate the CBCI from the amount of the polypropylene and polyethylene fractions and the weight % propylene present in each of the fractions that are separated by HTLC. The corresponding CBCI calculations for CBC1 are provided in Table 4, below.

TABLE 4

| Line # | Variable | Source | CBC1 |
|---|---|---|---|
| 1 | Overall wt % C3 Total | Measured | 52.400 |
| 2 | wt % C3 in PP block/polymer | Measured | 99.000 |
| 3 | wt % C3 in PE block/polymer | Measured | 10.500 |
| 4 | wt fraction PP (in block or polymer) | Eq. 2 below | 0.500 |
| 5 | wt fraction PE (in block or polymer) | 1-Line 4 | 0.500 |
| | Analysis of HTLC Separation | | |
| 6 | wt fraction isolated PP | Measured | 0.199 |
| 7 | wt fraction PE fraction | Measured | 0.801 |
| 8 | wt % C3 in PE-fraction | Eq. 4 below | 40.823 |
| 9 | wt fraction PP-diblock in PE fraction | Eq. 6 below | 0.343 |
| 10 | wt fraction PE in PE fraction | 1-Line 10 | 0.657 |
| 11 | wt fraction Diblock in PE fraction | 10/Line 4 | 0.685 |
| 12 | Crystalline Block Composite Index | Eq. 7 below | 0.549 |
| | (CBCI) | | |

Referring to Tables 3 and 4, above, the CBCI is measured by first determining a summation of the weight % propylene from each component in the polymer according to Equation 1, below, which results in the overall weight % propylene/C3 (of the whole polymer). This mass balance equation can be used to quantify the amount of the PP and PE present in the block copolymer. This mass balance equation can also be used to quantify the amount of PP and PE in a binary blend or extended to a ternary, or n-component blend. For the BCs and CBCs, the overall amount of PP or PE is contained within the blocks present in the block copolymer and the unbound PP and PE polymers.

Wt % C3_{Overall}=w_{PP}(wt % C3_{PP})+w_{PE}(wt % C3_{PE}) Eq. 1

where

w_{PP}=weight fraction of PP in the polymer

w_{PE}=weight fraction of PE in the polymer

wt % C3_{PP}=weight percent of propylene in PP component or block

wt % C3_{PE}=weight percent of propylene in PE component or block

Note that the overall weight % of propylene (C3) is measured from C¹³ NMR or some other composition measurement that represents the total amount of C3 present in the whole polymer. The weight % propylene in the PP block (wt % C3_{PP}) is set to 100 (if applicable) or if otherwise known from its DSC melting point, NMR measurement, or other composition estimate, that value can be put into its place. Similarly, the weight % propylene in the PE block (wt % C3_{PE}) is set to 100 (if applicable) or if otherwise known from its DSC melting point, NMR measurement, or other composition estimate, that value can be put into its place. The weight % of C3 is shown in Table 6.

Calculating the Ratio of PP to PE in the crystalline block composite and/or the specified block composite: Based on Equation 1, the overall weight fraction of PP present in the polymer can be calculated using Equation 2 from the mass balance of the total C3 measured in the polymer. Alternatively, it could also be estimated from a mass balance of the monomer and comonomer consumption during the polymerization. Overall, this represents the amount of PP and PE present in the polymer regardless of whether it is present in the unbound components or in the block copolymer. For a conventional blend, the weight fraction of PP and weight fraction of PE corresponds to the individual amount of PP and PE polymer present. For the crystalline block composite and the block composite, it is assumed that the ratio of the weight fraction of PP to PE also corresponds to the average block ratio between PP and PE present in this statistical block copolymer.

$${w}_{PP} = \frac{wt \% C {3}_{Overall} - wt \% C {3}_{PE}}{wt \% C {3}_{PP} - wt \% C {3}_{PE}} \qquad Eq . 2$$

where

w_{PP}=weight fraction of PP present in the whole polymer

wt % C3_{PP}=weight percent of propylene in PP component or block

wt % C3_{PE}=weight percent of propylene in PE component or block

To estimate the amount of the block copolymer (diblock) in the Crystalline Block Composite, apply Equations 3 through 5, and the amount of the isolated PP that is measured by HTLC analysis is used to determine the amount of polypropylene present in the diblock copolymer. The amount isolated or separated first in the HTLC analysis represents the ‘unbound PP’ and its composition is representative of the PP block present in the diblock copolymer. By substituting the overall weight % C3 of the whole polymer in the left hand side of Equation 3, and the weight fraction of PP (isolated from HTLC) and the weight fraction of PE (separated by HTLC) into the right hand side of Equation 3, the weight % of C3 in the PE fraction can be calculated using Equations 4 and 5. The PE fraction is described as the fraction separated from the unbound PP and contains the diblock and unbound PE. The composition of the isolated PP is assumed to be the same as the weight % propylene in the PP block as described previously.

$$\begin{matrix}wt \% C {3}_{Overall} = {w}_{PP isolated} ( wt \% C {3}_{PP} ) + {w}_{PE \text{-} fraction} ( wt \% C {3}_{PE \text{-} fraction} ) & Eq . 3 \\ wt \% C {3}_{PE \text{-} fraction} = \frac{wt \% C {3}_{Overall} - {w}_{PPisolated} ( wt \% C {3}_{PP} )}{{w}_{PE \text{-} fraction}} & Eq . 4 \\ {w}_{PE \text{-} fraction} = 1 - {w}_{PPisolated} & Eq . 5\end{matrix}$$

where

w_{PPisolated}=weight fraction of isolated PP from HTLC

w_{PE-fraction}=weight fraction of PE separated from HTLC, containing the diblock and unbound PE

wt % C3_{PP}=weight % of propylene in the PP; which is also the same amount of propylene present in the PP block and in the unbound PP

wt % C3_{PE-fraction}=weight % of propylene in the PE-fraction that was separated by HTLC

wt % C3_{Overall}=overall weight % propylene in the whole polymer

The amount of wt % C3 in the polyethylene fraction from HTLC represents the amount of propylene present in the block copolymer fraction that is above the amount present in the ‘unbound polyethylene’. To account for the ‘additional’ propylene present in the polyethylene fraction, the only way to have PP present in this fraction is for the PP polymer chain to be connected to a PE polymer chain (or else it would have been isolated with the PP fraction separated by HTLC). Thus, the PP block remains adsorbed with the PE block until the PE fraction is separated.

The amount of PP present in the diblock is calculated using Equation 6.

$${w}_{PP \text{-} diblock} = \frac{wt \% C {3}_{PE \text{-} fraction} - wt \% C {3}_{PE}}{wt \% C {3}_{PP} - wt \% C {3}_{PE}} \qquad Eq . 6$$

### Where

wt % C3_{PE-fraction}=weight % of propylene in the PE-fraction that was separated by HTLC (Equation 4)

wt % C3_{PP}=weight % of propylene in the PP component or block (defined previously)

wt % C3_{PE}=weight % of propylene in the PE component or block (defined previously)

w_{PP-diblock}=weight fraction of PP in the diblock separated with PE-fraction by HTLC

The amount of the diblock present in this PE fraction can be estimated by assuming that the ratio of the PP block to PE block is the same as the overall ratio of PP to PE present in the whole polymer. For example, if the overall ratio of PP to PE is 1:1 in the whole polymer, then it assumed that the ratio of PP to PE in the diblock is also 1:1. Thus, the weight fraction of diblock present in the PE fraction would be weight fraction of PP in the diblock (w_{PP-diblock}) multiplied by two. Another way to calculate this is by dividing the weight fraction of PP in the diblock (w_{PP-diblock}) by the weight fraction of PP in the whole polymer (Equation 2).

To further estimate the amount of diblock present in the whole polymer, the estimated amount of diblock in the PE fraction is multiplied by the weight fraction of the PE fraction measured from HTLC. To estimate the crystalline block composite index, the amount of diblock copolymer is determined by Equation 7. To estimate the CBCI, the weight fraction of diblock in the PE fraction calculated using Equation 6 is divided by the overall weight fraction of PP (as calculated in Equation 2) and then multiplied by the weight fraction of the PE fraction.

$$CBCI = \frac{{w}_{PP \text{-} diblock}}{{w}_{PP}} \cdot {w}_{PE \text{-} fraction} \qquad Eq . 7$$

### Where

w_{PP-diblock}=weight fraction of PP in the diblock separated with the PE-fraction by HTLC (Equation 6)

w_{PP}=weight fraction of PP in the polymer

w_{PE-fraction}=weight fraction of PE separated from HTLC, containing the diblock and unbound PE (Equation 5)

Various tie layers are prepared for use in multilayer films for this example. Inventive Tie Layer 1 represents a tie layer that can be used in some embodiments of a multilayer film of the present invention. Table 5 shows the composition of Inventive Tie Layer 1 and of Comparative Tie Layer A and Comparative Tie Layer B, with all values being weight percentages based on the total weight of the composition.

TABLE 5

| Tie | | MAH-g- | Lotader | Igetabond | ENGAGE | Irganox |
|---|---|---|---|---|---|---|
| Layer | CBC1 | HDPE | 8840 | E | 8130 | B225 |
| 1 | 57.3 | 25 | | | 17.5 | 0.2 |
| A | 49.8 | | 50 | | | 0.2 |
| B | 49.8 | | | 50 | | 0.2 |

The blends for the tie layers are compounded using a 30 mm Leistritz twin screw extruder. The extruder has five heated zones, a feed zone, and a 3 mm strand die. The feed zone is cooled by flowing water through its core, while the remaining zones 1-5 and die are heated electrically and controlled by air cooling to specified temperatures depending on the materials being blended. The following temperature settings are used in the extrusion process: Zones 1-5 are heated to 130, 186, 190, 190, and 190° C., and the die is heated to 190° C. The drive unit for the extruder is run at 150 rpm.

The tie layer blends are compression molded into plaques having a thickness of about 16.6 mils using a Carver hydraulic press at 190° C. PETG resins are also compression molded into plaques having a thickness of about 16.6 mil using a Carver hydraulic press at 190° C.

The homopolymer polypropylene resin (Adstif HA802H) is made into a blown film using a Lab Tech 5-layer blown film line. The diameter of the extrusion die is 75 mm and the die gap is 2 mm. The blow-up ratio (BUR) is 2.4 to 2.5 and the lay-flat width is 11.4 to 11.6 inch. The nip speed is 10.5 to 12.0 ft/min. The total film thickness is 5 mil.

A heat seal test is conducted based on ASTM Standard Test Method F88, which is a standard test method for seal strength of flexible barrier materials. This test measures the force required to separate a test strip of material containing the seal. It also identifies the mode of specimen failure. The test specimens are die cut strips that are one inch in width. The test result is a measure of the force required to pull apart the heat seal, or the force required to break the film in cases where the film breaks before the heat seal separates. The seals are formed at 180° C. and 210° C. as indicated below, with a 3 second dwell time, at a pressure of 0.05 N. Samples are prepared using each tie layer described above and PETG, and using each tie layer described above the hPP film.

The seal strengths of the different tie layer resins to PETG and to hPP substrates are shown in Table 6. Seal strength between tie layer resins to different substrates is an indication of adhesion between tie layer resins and different substrates. Higher seal strength between a tie layer resin and a substrate (PETG or hPP) indicates better adhesion.

TABLE 6

| | Seal strength to | | Seal strength to | | Seal strength to hPP | |
|---|---|---|---|---|---|---|
| | PETG (lb/in) (Sealed | | PETG (lb/in) (Sealed | | (lb/in) (Sealed at | |
| | at 180° C.) | | at 210° C.) | | 210° C.) | |
| Example | Peak Load | STDEV | Peak Load | STDEV | Peak Load | STDEV |
| Inv. Tie | 6.19 | 1.62 | 4.93 | 1.28 | 16.9 | 2.6 |
| Layer 1 | | | | | | |
| Comp. | 0.03 | 0.02 | 1.76 | 2.08 | not | — |
| Tie | | | | | measured | |
| Layer A | | | | | | |
| Comp. | 0.47 | 0.30 | 0.56 | 0.20 | not | — |
| Tie | | | | | measured | |
| Bayer B | | | | | | |

Inventive Tie Layer 1, based on a crystalline block copolymer composite and MAH-g-HDPE, provides good adhesion to both PETG and hPP. Comparative Tie Layers A and B, based on a blend of CBC and glycidyl methacrylate grafted polyethylene copolymers, have poor adhesion to PETG so that the adhesion to hPP is not measured.

1. A coextruded, multilayer film comprising at least five layers in which Layer A is a skin layer, Layer B is a tie layer, Layer C is a barrier layer, Layer D is a second tie layer, and Layer E is polyolefin, each layer having opposing facial surfaces and arranged in the order A/B/C/D/E, wherein:
Layer A comprises polyethylene terephthalate (PET);
Layer B comprises a maleic anhydride grafted polymer comprising ethylene monomer, a top facial surface of Layer B being in adhering contact with a bottom facial surface of Layer A;
Layer C comprises polyamide or ethylene vinyl alcohol;
Layer D comprises either:
(1) a maleic anhydride grafted polymer comprising ethylene monomer;
(2) a) a crystalline block copolymer composite (CBC) comprising:
i) a crystalline ethylene based polymer (CEP) comprising at least 90 mol % polymerized ethylene;
ii) an alpha-olefin-based crystalline polymer (CAOP); and
iii) a block copolymer comprising (a) a crystalline ethylene block (CEB) comprising at least 90 mol % polymerized ethylene and (b) a crystalline alpha-olefin block (CAOB);
b) optionally, a polyolefin elastomer;
c) maleic anhydride grafted polyethylene (MAH-g-PE) or maleic anhydride grafted polypropylene (MAH-g-PP); and
d) optionally, polypropylene or polyethylene, or
(3) a blend of polypropylene and maleic anhydride grafted polypropylene, a top facial surface of Layer D being in adhering contact with a bottom facial surface of Layer C; and
Layer E comprises polypropylene or polyethylene and, a top facial surface of Layer E being in adhering contact with a bottom facial surface of Layer D.

2. The coextruded, multilayer film of claim 1, wherein a top facial surface of Layer C is in adhering contact with a bottom facial surface of Layer B.

3. The coextruded, multilayer film of claim 1, wherein Layer B comprises (a) a blend of maleic anhydride grafted polyethylene and ethylene alkyl acrylate copolymer, (b) a blend of maleic anhydride grafted polyethylene and ethylene vinyl acetate copolymer, (c) a maleic anhydride grafted ethylene acrylate, (d) a maleic anhydride grafted ethylene vinyl acetate, or a combination thereof.

4. The coextruded, multilayer film of claim 1, wherein Layer D comprises (a) a blend of maleic anhydride grafted polyethylene and ethylene alkyl acrylate copolymer, (b) a blend of maleic anhydride grafted polyethylene and ethylene vinyl acetate copolymer, (c) a maleic anhydride modified ethylene acrylate, (d) a maleic anhydride grafted ethylene vinyl acetate, or a combination thereof.

5. The coextruded, multilayer film of claim 1, further comprising Layer F and Layer G, wherein a top facial surface of Layer F is in adhering contact with a bottom facial surface of Layer B, wherein a top facial surface of Layer G is in adhering contact with a bottom facial surface of Layer F, wherein a top facial surface of Layer C is in adhering contact with a bottom facial surface of Layer G, wherein Layer F comprises polypropylene, and wherein Layer G is a third tie layer comprising either:
(1) a maleic anhydride grafted polymer comprising ethylene monomer, or
(2) a) a crystalline block copolymer composite (CBC) comprising:
i) a crystalline ethylene based polymer (CEP) comprising at least 90 mol % polymerized ethylene;
ii) an alpha-olefin-based crystalline polymer (CAOP); and
iii) a block copolymer comprising (a) a crystalline ethylene block (CEB) comprising at least 90 mol % polymerized ethylene and (b) a crystalline alpha-olefin block (CAOB);
b) optionally, a polyolefin elastomer;
c) maleic anhydride grafted polyethylene (MAH-g-PE) or maleic anhydride grafted polypropylene (MAH-g-PP); and
d) optionally, polypropylene or polyethylene, or
(3) a blend of polypropylene and maleic anhydride grafted polypropylene.

6. The coextruded, multilayer film of claim 5, wherein Layer G comprises the same composition as Layer D.

7. The coextruded, multilayer film of claim 6, wherein Layer G and Layer D comprise the same composition as Layer B.

8. The coextruded, multilayer film of claim 1, wherein Layer G comprises:
a) a crystalline block copolymer composite (CBC) comprising:
i) a crystalline ethylene based polymer (CEP) comprising at least 90 mol % polymerized ethylene;
ii) an alpha-olefin-based crystalline polymer (CAOP) and
iii) a block copolymer comprising (a) a crystalline ethylene block (CEB) comprising at least 90 mol % polymerized ethylene and (b) a crystalline alpha-olefin block (CAOB);
b) optionally, a polyolefin elastomer;
c) maleic anhydride grafted polyethylene (MAH-g-PE) or maleic anhydride grafted polypropylene (MAH-g-PP); and
d) optionally, polypropylene or polyethylene.

9. The coextruded, multilayer film of claim 1, wherein Layer C comprises polyamide, and further comprising Layer F and Layer G, wherein a top facial surface of Layer F is in adhering contact with a bottom facial surface of Layer B, wherein a top facial surface of Layer G is in adhering contact with a bottom facial surface of Layer F, wherein a top facial surface of Layer C is in adhering contact with a bottom facial surface of Layer G, wherein Layer F comprises polyamide, and wherein Layer G comprises ethylene vinyl alcohol.

10. The coextruded, multilayer film of claim 1, wherein Layer E comprises polypropylene.

11. The coextruded, multilayer film of claim 1, wherein the multilayer film is coextruded in a single step.

12. The coextruded, multilayer film of claim 1, wherein the film is a blown film or a cast film.

13. The coextruded, multilayer film of claim 1, wherein Layer D comprises:
a) a crystalline block copolymer composite (CBC) comprising:
i) a crystalline ethylene based polymer (CEP) comprising at least 90 mol % polymerized ethylene;
ii) an alpha-olefin-based crystalline polymer (CAOP) and
iii) a block copolymer comprising (a) a crystalline ethylene block (CEB) comprising at least 90 mol % polymerized ethylene and (b) a crystalline alpha-olefin block (CAOB);
b) optionally, a polyolefin elastomer;
c) maleic anhydride grafted polyethylene (MAH-g-PE) or maleic anhydride grafted polypropylene (MAH-g-PP); and
d) optionally, polypropylene or polyethylene.

14. An aseptic package formed from the multilayer film of claim 1.

15. The aseptic package of claim 14, wherein the package includes a liquid.
